(19) United States
(12) Patent Application Publication
(10) Pub. No.: US 2018/0250778 A1
(43) Pub. Date: Sep. 6, 2018

(54) MACHINE FOR BENDING A THREAD-LIKE MATERIAL SUCH AS A PIPE EQUIPPED WITH AN ABOARD CUTTING DEVICE

(71) Applicant: CRIPPA S.p.A, Arosio (CO) (IT)

(72) Inventor: Michele Fumagalli, Arosio (CO) (IT)

(21) Appl. No.: 15/910,351

(22) Filed: Mar. 2, 2018

(30) Foreign Application Priority Data
Mar. 2, 2017 (IT) 102017000023611

(51) Int. Cl. B23K 37/053; B23K 10/00; B23K 26/38; B21D 7/00; B25B 11/00

(52) U.S. Cl. CPC B23K 37/053; B23K 10/00; B23K 2201/06; B21D 7/00; B25B 11/005; B23K 26/38

(57) ABSTRACT

A machine for bending a thread-like material such as a pipe equipped with a laser or plasma cutting device aboard the machine and guide means for making said cutting device slide.

### OBJECT OF THE INVENTION

The object of the present invention is a machine for bending a thread-like material such as a pipe equipped with an aboard laser or plasma cutting device suitable for reducing the machining times and making the thread-like material cutting operations more accurate.

### PRESENT STATUS OF THE ART

For production reasons, it shall be possible to submit a thread-like material such as a pipe, here below referred to as “pipe”, to cutting in order to create bores of different shapes and dimensions, an operation that is briefly referred to as “drilling” here below, before bending it or after bending it.

The cutting operations performed to make the mentioned bores in a pipe are performed by machines that are different and separate from bending machines

If a pipe has to be drilled before bending, the pipe is drilled by using an appropriate machine and is subsequently loaded onto a bending machine for the bending procedures according to the various machining programs. Said type of machining entails a big waste of time as necessary to transfer the pipe to be machined from one machine to the other, as well as a waste of time to perform a correct positioning of the perforated pipe to bend onto the bending machine.

If a pipe has to be drilled after being bent, the bent pipe shall be transferred from the bending machine to the cutting one. In this event transferring the bent pipe from the bending machine to the cutting one also entails, besides transfer times, a difficulty in handling and correctly positioning the bent pipe onto the cutting machine to proceed with the specified machining.

In both types of production described in the previous paragraphs, the pipes are stockpiled before being loaded in order for them to be submitted to the next machining step.

If a pipe has to be drilled before bending, several pipes are drilled and a quantity of perforated pipes, as set by the machining program, is stockpiled and only at a later time are those stockpiled pipes gradually loaded onto the bending machine for the bending procedures according to the various machining programs.

If pipes are drilled after being bent, several pipes bent in a quantity as set by the machining program are stockpiled and only at a later time are they gradually loaded onto the cutting machines. In this event, in addition to the problems related to transfer bent pipes from the bending machine to the cutting one, and besides the difficulty in handling the bent pipe, there are also problems in stockpiling the bent pipes, which cannot be simply piled up but shall also be positioned in such a way that their surfaces and ends remain intact while being stockpiled.

As mentioned in the previous paragraphs, being obliged to use two different machines for bending pipes and for drilling them makes it necessary a repositioning activity for the various pipes, which has great importance. Let's think, for instance, to the difficulties resulting from an exact identification of welding, considering that bending shall be properly oriented with respect to pipe welding. Being obliged to position cutting before and to subsequently transfer the pipe onto the bending machine entails a need for also repositioning welding twice. In the present status of the art, such positioning takes place manually or by using a robot. A drawback of such known solutions is in that an operator shall be appointed to a repetitive and alienating activity or, if a robot is used, complex and extensive robot programming activities shall be faced up to.

Conversely, in the case of bent pipes that shall be drilled afterwards the known art shall face up to the problem of calculating the cutting positions with respect to the bending positions, in that it is necessary to have references in order to proceed with such operation, as it is necessary to solve the problem of positioning the cutting position with respect to the bending position.

### DISCLOSURE OF THE INVENTION

The drawbacks of the known machines are solved by a machine according to the present invention.

Being not obliged to transfer a pipe to bend and drill or to drill and bend from one machine to another definitely embodies an advantage. However, as far as drilling operations are concerned, it is necessary that a pipe can be handled horizontally and also made rotate upon itself to proceed with the drilling operations in all necessary positions of the surface of the pipe. For a correct drilling, it shall be possible for the cutting device to get closer to and move away from the surface of the pipe to be drilled according to specific machining programs, the distance of the cutting element from the surface of the pipe being conditional on the resistance to shearing stress characteristics of the surface of the pipe, on the cutting force of the device, and on the need for a greater or lower drilling accuracy. Also, to be able to make bores of different shapes, the cutting device shall be capable of moving horizontally, circularly, or according an up-and-over movement.

The machine according to the present invention is suitable for achieving the above-mentioned goals, by making it unnecessary to transfer pipes from the bending machine to the cutting one and vice versa, being equipped with a first cutting device aboard the bending machine.

The machine according to the present invention comprises a fixed support frame on which a pipe handling and rotation carriage, here below shortly referred to as handling carriage, slides. Such handling carriage slides on a plane of the fixed support frame. Such handling carriage positions the pipe to be machined onto the bending head, but it is also suitable for bringing the bent pipe back onto the sliding plane of said carriage. Such handling carriage is also suitable for making the pipe rotate upon itself before, while, and after being bent.

Such characteristics of the handling carriage make it possible to proceed with pipe drilling both before its bending and afterwards by using a first cutting device. Such device can be alternatively a laser or plasma device. Such device slides along guide means located above the fixed support frame and specifically above the sliding plane of the pipe handling carriage.

Said guide means of the first cutting device consist of at least one rail and said rail is preferably parallel to the plane on which the mentioned handling carriage slides.

The guide means are also equipped with a second handling device which is associated with the first cutting device. Said second handling device is suitable for making the first cutting device get closer or move away vertically, as well as for moving said cutting device horizontally.

In a preferred embodiment, the second handling device is also suitable for moving the first cutting device circularly or up-and-over. Said second handling device is connected to a programmable control unit in order to handle the first cutting device according to a machining program set up by the machine manufacturer or by the user.

Cutting a pipe unavoidably produces swarf. Such swarf shall be removed from the perforated pipe and for this activity the machine according to the present invention comprises a third swarf suction device. Such third suction device is connected to the guide means or alternatively to the second handling device which moves the first cutting device. In the embodiment that comprises such third suction device connected to the guide means, said third suction device is equipped with a fourth handling device to move the third suction device along the guide means where the first cutting device slides.

Should the dimensions of the swarf be too large for the third swarf suction device, such device is equipped with suction device blocking means. Such blocking means might be properly programed sensors.

The machine according to the present invention is also equipped with sensors alternatively or jointly placed on the sliding plane of the pipe handling carriage and/or on the first guide means. Such sensors connected to a programmable control unit are connected to the handling carriage to position it according to an appropriate machining program in order to accurately proceed with drilling the pipe according to the provisions of said machining program.

An advantage of the machine according to the present invention, which combines the two above-mentioned machining processes in one machine, is in that its operation can be controlled by the operator by using appropriate visual control means, for instance dedicated cameras, the operators being sheltered from the harmful light of the cutting device. Let's think to booths in which operators can be sheltered while controlling the pipe bending and cutting or cutting and bending operations via appropriate monitors connected to appropriate and specific cameras by using a machine according to the present invention.

### DESCRIPTION OF THE FIGURES

FIGS. 1 thru 4 show a machine according to the present invention in a three-dimensional way.

FIG. 1 shows a machine according to the present invention equipped with a fixed support frame (1) on which a pipe (T) handling carriage (2) slides on a plane of the fixed support frame. Such handing carriage positions the pipe (T) to be machined onto the bending head (3), but it is also suitable for bringing the bent pipe (T) back onto the sliding plane (6) of said carriage (2). Such handling carriage (2) is also suitable for making the pipe rotate upon itself before, while, and after being bent. Such characteristics of the pipe handling carriage (2) make it possible to start drilling the pipe both before and after its bending by using a first cutting device (5). Such device is either a laser or plasma device. Said device slides along guide means (4) placed above the fixed support frame (1) and in particular above the sliding plane (6) of the pipe (T) handling carriage (2). Said guide means (4) of the first cutting device (5) consist of at least one rail and said rail is preferably parallel to the plane (6) on which the mentioned handling carriage (2) slides. The guide means (4) are also equipped with a second handling device (6) which is associated with the first cutting device (5). Said second handling device (7) is suitable for making the first cutting device (5) get closer or move away vertically, as well as for moving said cutting device (5) horizontally. In a preferred embodiment, the second handling device (7) is also suitable for moving the first cutting device (5) circularly of up-and-over. Said second handling device (7) is connected to a programmable control unit in order to move the first cutting device (5) according to a machining program set up by the machine manufacturer or by the user. Cutting the pipe (T) unavoidably produces a swarf. Such swarf shall be removed from the perforated pipe (T) and for this activity the machine according to the present invention is equipped with a third suction device (8) for sucking said swarf, not shown in the figures. Said third suction device (8) is connected either to guide means (4) or to the second handling device (7) which moves the first cutting device (5). In the embodiment wherein the third suction device (8) is connected to the guide means (4), said third suction device (8) is equipped with a fourth handling device, not shown in the figures, which moves the third suction device (8) along the guide means (4) where the first cutting device (5) slides. If the dimensions of the swarf are too large for the third swarf suction device (8), said device is equipped with blocking means (9), not shown in the figures, to block the third suction device (8). Such blocking means (9) might be properly programed sensors. The machine according to the present invention is also equipped with sensors, not shown in the figures, located alternatively or jointly on the sliding plane (6) of the pipe (T) handling carriage (2) and/or on the guide means (4). Such sensors connected to a programmable control unit are connected to the pipe (T) handling carriage (2) to position it according to an appropriate machining program in order to start accurately drilling the pipe (T) according to the provisions of said machining program.

FIG. 2 shows a machine according to the present invention, the pipe (T) handling carriage (2) bringing onto the sliding plane (6) of said carriage (2) the pipe (T) already bent and ready for being drilled by using the first cutting device (5).

FIG. 3 shows a machine according to the present invention, the pipe (T) handling carriage (2) bringing the bent and drilled pipe (T) beyond the bending head (3) for being cut by using the cutting device (5).

FIG. 4 shows a machine according to the present invention, the pipe (T) handling carriage (2) having brought the bent and drilled pipe (T) beyond the bending head (3), the cutting device (5) having cut said bent and drilled pipe (T), thus ending a machining cycle.

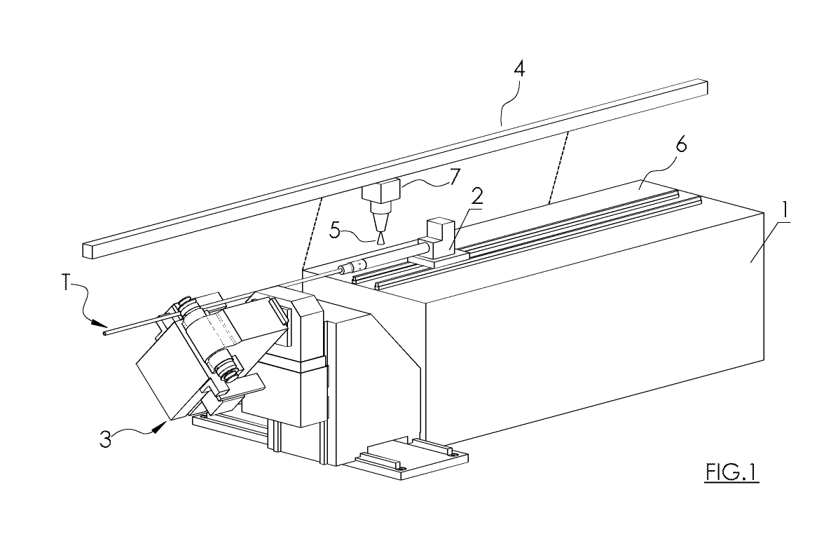

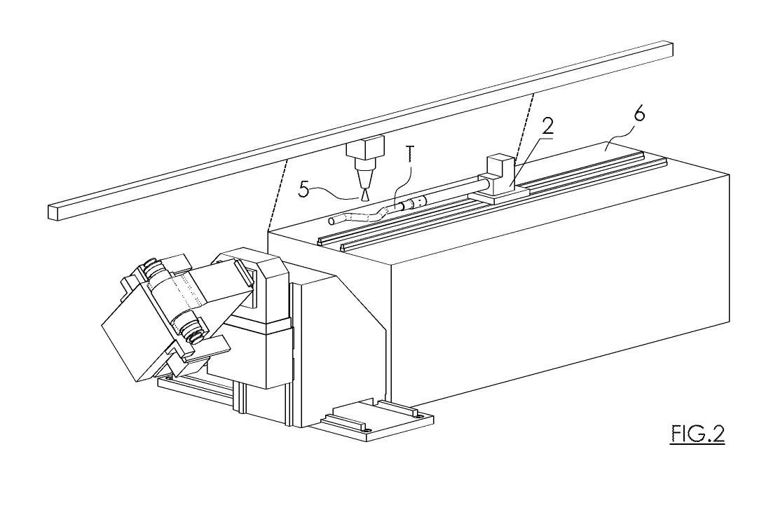

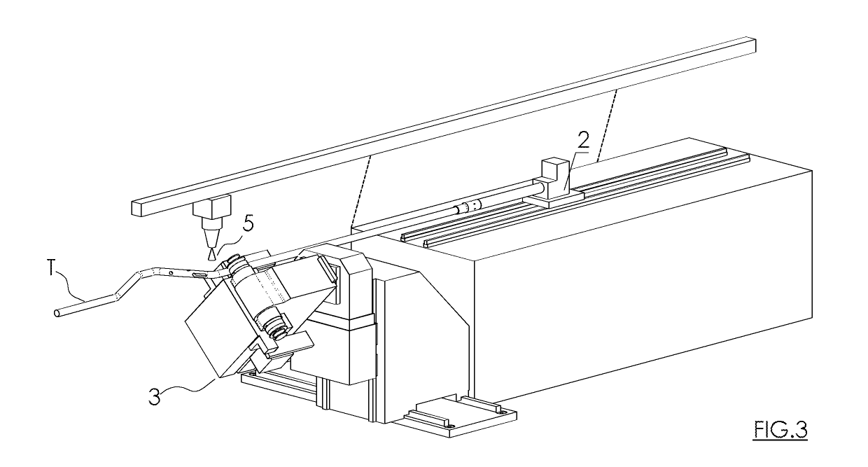

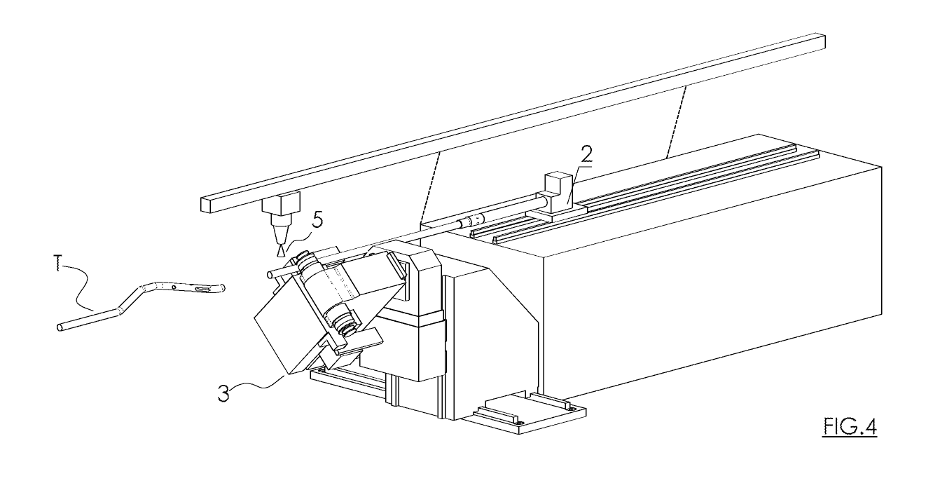

1. A machine for bending a thread-like material such as a pipe comprising:
a fixed support frame;
a carriage for handling and driving into rotation the pipe (T) to be machined;
a bending head,
comprising sliding guide means for at least a first, either laser or plasma, cutting device.

2. A machine according to claim 1, wherein the guide means are placed above the fixed support frame.

3. A machine according to claim 2, wherein the guide means consists of at least one rail.

4. A machine according to claim 2, wherein the guide means comprise at least a second handling device associated with the first cutting device and suitable for making the first cutting device vertically get closer to or move away from the portion of the pipe (T) to be machined.

5. A machine according to claim 4, wherein the second handling device is suitable for moving the first cutting device horizontally.

6. A machine according to claim 4, wherein the second handling device is suitable for moving the first cutting device either in a circular direction or up-and-over.

7. A machine according to claim 2, wherein the second handling device is equipped with a third suction device for sucking the small-size swarf resulting from cutting the pipe (T) to be machined.

8. A machine according to claim 6, wherein the third small-size swarf suction device is equipped with blocking means for blocking the third suction device, should the swarf size exceed the longitudinal cross-section of the third suction device.
